(19) United States
(12) Patent Application Publication
(10) Pub. No.: US 2003/0178294 A1
(43) Pub. Date: Sep. 25, 2003

(54) Device for distilling a medium

(76) Inventors: Mark Braendli, Erlinsbach (CH); Markus Lehmann, Wohlen (CH)

Correspondence Address: WENDEROTH, LIND & PONACK, L.L.P., 2033 K STREET N. W., SUITE 800, WASHINGTON, DC, 20006-1021, US

(21) Appl. No.: 10/333,962

(22) PCT Filed: Jul. 16, 2001
(86) PCT No.: PCT/CH01/00442

(30) Foreign Application Priority Data
Jul. 27, 2000 (CH) 1487/00

(51) Int. Cl. B01D 3/10

(52) U.S. Cl. 202/205; 202/160; 202/185.1; 202/182; 203/91; 203/39; 203/2

(57) ABSTRACT

The inventive device for distilling a medium comprises at least one reservoir (11, 51) or accommodating the medium (15, 55) to be distilled, a heating element (12, 52) for vaporizing the medium (55), and comprises at least one collecting vessel (20, 60), which is situated downstream and which is provided with a cooling element for condensing the produced distillation vapor. In addition, a pipe (19, 59) or the like is provided on the top side of the reservoir (11, 51). Said pipe leads into the collecting vessel (20, 60) and connects the vapor space (14, 54) located inside the reservoir (51) to that which is located inside the collecting vessel (20, 60). To this end, means are provided, which, for the most part, completely remove foreign gases from the vapor spaces (14, 24; 54, 64) before or at the beginning of the distillation process. At least one vacuum pump or a scrubbing device is provided as said means, with which the foreign gases in the vapor spaces (14, 24; 54, 64) can he removed by suction or scrubbing. This enables optimal conditions to be attained with regard to the energy budget and to the functioning of the device.

The invention concerns a device for the distilling of a medium and comprises at least one reservoir for accommodating of the medium to be distilled as well as a heating element for the vaporising of the medium and at least one collecting vessel which is situated downstream, with at least one cooling element for the condensing of the produced distillation vapour, as well as a pipe or the like on the top side of the reservoir which leads to the collecting vessel and which connects the vapour spaces located inside the reservoir to those which are located inside the collecting vessel.

A distilling device of this kind will subject the mixture that is to be distilled to a heating element and underpressure inside a closed reservoir until the liquid on the surface of the bath is vaporised. The vapour that is produced in this way is then routed via a pipe located on the upper side of the reservoir and is subsequently converted into a liquid distillate through compression or cooling.

Some disadvantages of distilling devices of this kind are the high energy budget connected with the same which is caused by heating the medium to boiling point, the high temperature level of the overall process, the large temperature or pressure drops and the subsequent compression and cooling of produced vapour, especially for example when water in to be distilled in large quantities.

This invention therefore aims to provide a device for the distilling of a medium according to the above mentioned principles which will nevertheless provide an optimal energy budget, an improved temperature level, and a problem-fee distillation process.

The task is solved in accordance with the invention in the way that methods are provided to be able to free the vapour reservoirs from foreign gases almost completely prior to or at the beginning of the distillation process.

The device according to this invention will provide optimal conditions with regard to energy budget and the functionality of the same.

One particularly advantageous embodiment envisages the routing of the liquid medium present in the collecting vessel and/or in the reservoir with the aid of a pump into separate pipes and then into the vapour space of the reservoir and/or into the vapour space of the collecting vessel.

A further embodiment of this invention incorporates a number of paired and simultaneously acting reservoirs and collecting vessels, whereby each vessel is connected to the side that is to be distilled, i.e. the bide that is to be condensed, which makes it possible that liquid can be fed into the device at that point where the best temperature level exists, and especially during the vaporising in the next cooler, i,e. during the condensing in the next warmer element. This cascade-like construction of the distillation device makes a maximised energy budget during the distillation process possible.

One embodiment of this invention as well as further advantages of the same will be found in the following description with reference to the drawings, whereby:

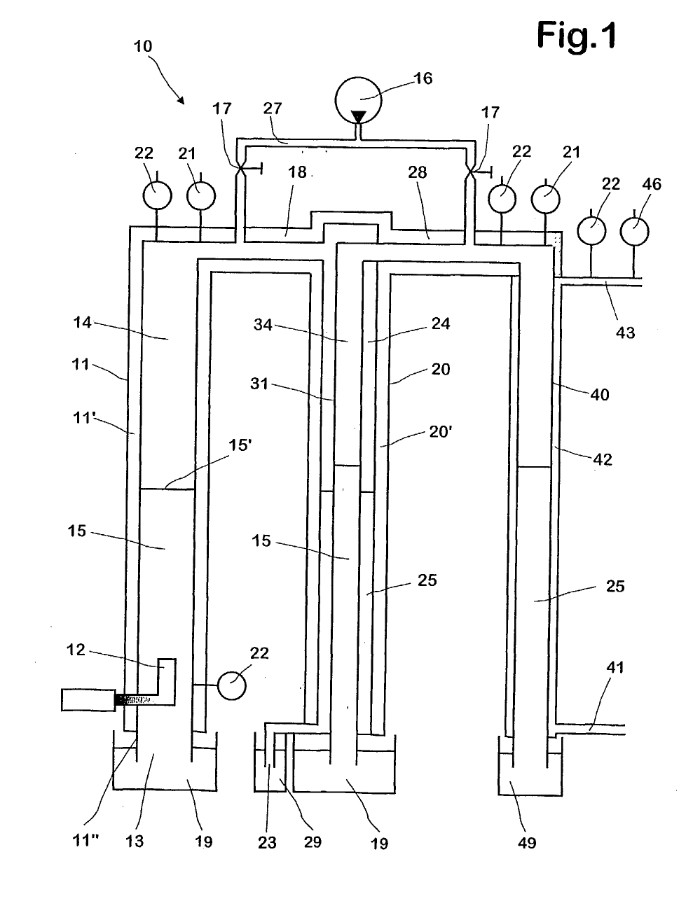

FIG. 1 shows a schematic length-section through a device according to this invention;

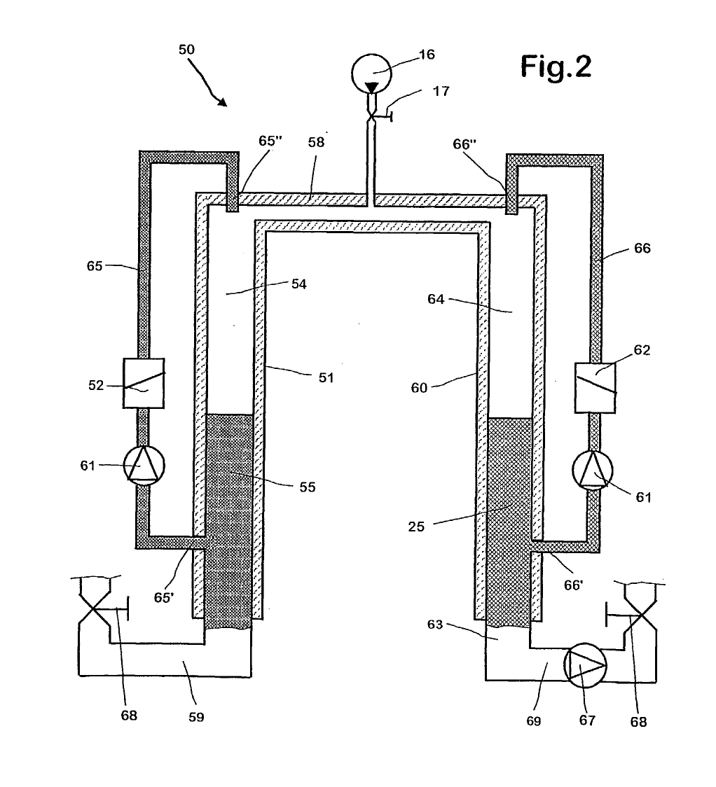

FIG. 2 shows a principal schematic diagram of a length-section of a device according to this invention;

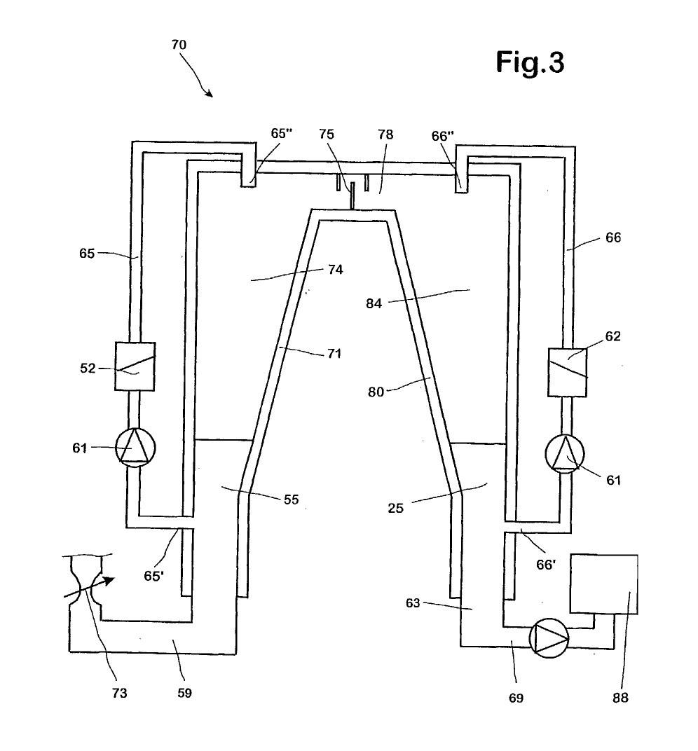

FIG. 3 shows a principal schematic diagram of a length-section of a further device according to this invention.

FIG. 1 shows a device (10) for the distilling of a medium (15), whereby the medium (15) consists of contaminated water, of mud-containing media, of salt water for the production of salt, of chemical liquid mixtures such as for example oil mixtures, or of similar media.

The device (10) incorporates a first reservoir (11) for the collection of the medium (15) to be distilled and a beating element (12) contained within the same for the heating of the medium. On the upper side of the reservoir (11) is a pipe (18) leading to a neighbouring collecting vessel (20). The distillation vapour condenses along the walls (31). The reservoir (11) further contains an enclosed vapour space (14) above the bath level (15′). This is connected to the vapour space (24) inside the collecting vessel (24). In this vapour space (14) of the reservoir (11) an equilibrium is formed due to the temperature dependent vapour pressure of the medium (15) and the vapour.

According to this invention the device incorporates methods with which the vapour spaces (14, 24, 34) can be freed almost completely from foreign gases prior to or at the beginning of the distillation process.

The device (10) is further characterised in accordance with this invention in that it contains two paired and simultaneously acting reservoirs (11, 31) and collecting vessels (20, 40), whereby one collecting vessel (20) and one reservoir (31) that does not correspond with the same are positioned inside one another in such a way that the distillate (25) produced in this collecting vessel (20) warms the medium (15) contained in the reservoir (31). This cascade-like construction enables the setting free of heat energy that is produced by the condensation of the distillate (25) and the transfer of the same to the medium (15) and therefore enables the repeated use of this heat for the vaporisation of the same.

The second reservoir (31) which is coaxially positioned in the collecting vessel (20) is also connected to do pump (16) for the production of an underpressure inside the vapour space (34) and is coupled via a pipe (28) with a collecting vessel (40). The latter is enclosed inside a cooling device (41, 42, 43) so that the distilled vapour can be liquefied to form the distillate (25).

The reservoir (11) and the collecting vessel (20) further preferably include one outlet (13, 23) each on the floor (11′) of the same which are each submersed in a bath (19, 29) of medium (15). i.e. distillate (25). For this purpose the vapour spaces (14, 34) and the reservoirs (11, 31) are connected to a pump (16) that preferably consists of a vacuum pump via pipes (27), and each one includes one controllable shut-off valve (17). This pump (16) is preferably of a capacity that will enable it to suction medium from the bath (19) and lift it to the nominal level required, and that will further free the vapour spaces (14, 34) from foreign gases in this way.

The reservoirs (11, 31) as well as the collecting vessels (20, 40) each take the form of pipes with a height of preferably several meters in accordance with this invention, for example between 5 and 10 metres. The lower outlets (13, 23) of the same project directly into the relevant associated bath (19, 29), which contains the medium (15), i.e. the distillate (25). In principle the reservoirs and collecting vessels can take a shape other than a pipe, for example a box-like shape.

The underpressure present inside the relevant vapour space (14, 34) that has been freed from the foreign gases is created automatically, i.e. it is dependent on the specific medium and the vapour pressure of the same that exists in its heated condition. The absolute pressure will be somewhere within the advantageous range of between 0.05 and 1.0 bar, and the temperature of the heated medium will be between 10° C. and 100° Celsius. The relevant bath (19, 29) is externally arranged in open way and is accordingly subject to atmospheric pressure. The bath levels inside the reservoir (11) and inside the associated collecting vessel (20) are therefore always the same due to the connecting vapour space.

This particular embodiment of the invention incorporates two simultaneously acting pipe pairs. However, in the context of a cascade-like device it is possible to use a number of such pipe pairs that are arranged downstream of and in series with one another like the reservoir (31) and the collecting vessel (20) that is enclosing the same.

The relevant gauges (21, 23) can provide detailed information about the device which will enable an optimal manipulation of the heating and cooling performance. It is possible to incorporate further elements, for example a float switch for the measurement or determination of larger deviations of the liquid level inside the reservoir (11, 31), i.e. inside the vessel (20, 40).

The reservoirs (11, 31) and the collecting vessels (20, 40) can be positionally arranged together with the relevant bath (19, 29, 49) inside a closed chamber, which can be subjected to a variable pressure, and preferably to an underpressure. This would enable an improved control of the device.

FIG. 2 shows a device (50) with a reservoir (51) for the collecting of the medium (55) that is to be distilled, a downstream collecting vessel (60), as well as a pipe (58) or suchlike connecting the same. An underpressure can be created inside the vapour space (54) between the reservoir (51) and the vessel (60) with the aid of the pump (16) and a controllable valve (17).

A further important aspect of the invention apart from the creation of vapour spaces (54, 64) that are free from foreign gases is one pipe each (65, 66) for the reservoir (51) as well as for the collecting vessel (60) which will route the liquid medium (55, 25) contained therein into the vapour space (55, 64) positioned above the same with the aid of a pump (61). The heating element (52) is contained inside the pipe (65) near the reservoir (51), whilst the cooling element (62) is contained inside the pipe (66). This layout enables an optimal heat transfer.

The inlet (65′, 66′) of the pipe (65, 66) is located in the area below the reservoir (51), i.e. the vessel (60), whilst the relevant outlet (65″, 66″) is located above the bath. Depending on the setting of the pump the heated liquid medium (55) falls through the relevant outlet (65″, 66″) either in drop or in the form of a stream, and then through the vapour space (54) into the bath. At the octet (66″) the condensed medium (25) falls through the vapour space (54) and into the bath either in drop form or in the form of a stream.

The feed of the medium (55) that is to be distilled, i.e. the drainage of the distillate is effected in this particular embodiment with the aid of a feed pipe (59) leading to the reservoir (51), i.e. a drainage pipe (69) leading from the vessel (60) which each incorporate a shut-off valve (68). Depending on the individual medium and also on the assumed reduced height of the device the distillate can be actively dosed with the aid of a pump (67) and routed via the pipe (69). The falling time of the drops between the outlet (66″) and their impact into the bath can thus be increased by effectively lowering the bath level of the distillate. In principle the outlet (66″) could be directed upwards and into the vapour spaces (54, 64) at the side in the same way as that of the vessel (51). It would also be possible to incorporate several outlet in different positions.

The feed pipe (59) near the reservoir (51) could in principle also be formed directly through the pipe (65). The reservoir (51) would then be advantageously closed at the bottom. The feed, i.e. drainage pipe (59, 69) as well as the pipes (65, 66) must not lead to the same reservoir, i.e. the same vessel from which the liquid has been pumped. With a layout according to FIG. 1 that incorporates one or more cascades the pumped medium can also be fed to the next cascade step.

A closed sump may also be used below the pipe-shaped reservoir in place of the feed pipe (59) shown in FIG. 2 or in place of the bath (19) shown in FIG. 1. The level of the medium within the bath would then not be located inside the pipe reservoir, but instead below inside the sump. This would for example enable the processing of lots instead of the continual processing that is produced within device that is shown in FIG. 1. This type of device is therefore suitable and preferred for the drying of moist solid particles or sludges.

It is possible to integrate a supply pump or a ventilator inside the pipe (58) that connects the reservoir (51) with the collecting vessel (60) with which the capacity of the distilling device could be increased. For larger temperature drops it would even be possible to utilise the associated pressure drop with the aid of a turbine fitted inside the connecting pipe (58).

The cleaning of the device, and especially of the reservoir (11, 31) could be effected with the aid of a cleaning mechanism that is not shown here, and which could for example integrate a scrubber, a coil, a brush or suchlike.

The device could further incorporate methods for the production of vapour bubbles in the medium that is to be distilled in order to create turbulence on the liquid surface and avoid the formation of crusts or suchlike.

It would further be possible to incorporate methods with which the medium that is to be distilled can be activated with a streaming current, for example by rotating the reservoir or by stirring the medium with a rotating propeller or suchlike.

The upper area of the reservoir could further be equipped with a shut-off device which would prevent the ingress of contaminated liquid, foam or suchlike through the pipe into the distilled liquid.

FIG. 3 shows a further embodiment of the device (70) which is constructed basically similarly to that illustrated in FIG. 2. The illustration therefore only shows those areas that are affixed with different numerals from those shown in FIG. 2. The device mainly consists of a reservoir (71) and a collecting vessel (80) which are equipped with a cross-sectional enlargement of the relevant vapour spaces (74, 84) in their upper area. This arrangement will enable an improved mixing of the liquid injected at the top through the outlets (65″, 66″) and into the relevant vapour spaces (74, 84). The connecting pipe (78) between the two vapour spaces is equipped with the indicated baffles (75) or suchlike so that dirt particles cannot be introduced into the collect vessel (84).

With smaller and more compact devices than those illustrated here it may be considered advantageous if the collecting vessel can be followed by a downstream interim container (88) in order to prevent possible flooding during a malfunction of the device. The feed pipe (59) could further incorporate a control valve (79) with which the feed quantity of contaminated liquid that is fed into the reservoir (71) could be controlled.

This device (70) can also be constructed in such a way that several such units are positioned cascade-like next to one another.

The invention has now been sufficiently illustrated with reference to the above examples as well as to the various possible embodiments. It would of course be possible to illustrate further embodiments. It would be possible for example that the reservoirs of the cascade illustrated in FIG. 1 could consist of commercially available heat exchangers. Instead of the vacuum pump for the extraction of the gases inside the vapour spaces these could be removed through flushing of the same with heated steam.

1. A device for the distilling of a medium that comprises at least one reservoir (11, 51) for accommodating the medium (15, 55) to be distilled, and a heating element (12, 52) for vaporising the medium (55), and that comprises at least one collecting vessel (20, 60) which is situated downstream, and that is provided with a cooling element for condensing the produced distillation vapour, in addition a pipe (18, 58) or the like is provided on the top side of the reservoir (11, 51). Said pipe connects the vapour space (14, 54) within the reservoir (51) with the relevant associated collecting vessel (20, 60), characterised in that it incorporates methods to free the vapour spaces (14, 24; 54, 64) from foreign gases prior to or at the beginning of the distillation process.

2. A device according to claim 1, characterised in that the method includes at least a vacuum pump or a flushing mechanism with which the foreign gases can be sectioned from or flushed out of the vapour spaces (14, 24; 54, 64).

3. A device according to claim 1 or 2, characterised in that an underpressure can be created the vapour space (14, 24; 54, 64) within the reservoir (11, 51), i.e. the collecting vessel (20, 60).

4. A device according to one of the above claims 1 to 3, characterised in that the liquid mediums (55, 25) that is present within the reservoir (51) and/or within the collecting vessel (60) is fed with the aid of a pump (61) through an individual separate pipe (65, 66) into the vapour space (54) of the reservoir (51) and/or into the vapour space (64) of the collecting vessel (60).

5. A device according to claim 4, characterised in that each of the inlets (65′, 66′) of the pipes (65, 66) positioned in the lower area of the reservoir (51), i.e. of the vessel (60), whilst the relevant outlet (65″, 66″) is positioned above the bath.

6. A device according to claim 5, characterised in that depending on the setting of the pump capacity the heated liquid medium (55), i.e. the condensed medium (25) falls through the outlet (65″) and through the relevant vapour space (54, 64) into the bath in the form of drops or as a stream.

7. A device according to one of the preceding claims 1 to 4, characterised in that the reservoir (11, 31; 51) as well as the collecting vessel (20, 40; 60) are each shaped lie pipes with a height of preferably several metres whereby the vapour space is freed from foreign gases with the aid of vacuum pump (16) and whereby an underpressure is created, which will extend from the reservoir (11, 35; 51) through the pipe (18, 28) and into the collecting vessel (20).

8. A device according to one of the preceding claims, characterised in that the level of the bath on the vaporising side is lowered in such a way that it will be present in a sump below the pipe reservoir, which is connected to the pipe reservoir and which is closed off from the outside.

9. A device according to one of the preceding claims, characterised in that the pressure within the vapour space which is free from foreign gases is lowered in such a way that is equals the vapour pressure of the liquid of most solid particles or sludges.

10. A device according to one of the above claims, characterised in that the collecting vessel is equipped with a suction pump by which the distilled medium can be kept to a lower bath level, whereby the vapour space is therefore enlarged by increasing the time period during which the drop remains within vapour space and the heat exchanger.

11. A device according to one of the preceding claims, characterised in that a supply pump, i.e. a ventilator integrated in the pipe that connects the reservoir with the collecting vessel in order to increase the capacity, whereby this may create at a certain capacity an undercooling on the vapour side and an overheating on the condensing side.

12. A device according to one of the preceding claims 1 to 10, characterised in that a turbine is located within the pipe that connects the reservoir to the collecting vessel which utilises the pressure drop caused by large temperature drops between the vaporising and condensing side and the vapour power produced in this way.

13. A device according to one of the preceding claims 1 to 4, characterised in that the same incorporates a reservoir (71) and/or a collecting vessel (80) that contains a cross-sectional enlargement of the relevant vapour space (74, 84) in its upper area.

14. A device according to one of the preceding claims, characterised in that the reservoir (11) and/or the collecting vessel (20) are open on the underside and therefore each contain an outlet (13, 23) at the bottom that each projects into a bath (19, 29) that is filled with the medium (15), i.e. the distillate (25), and in that the reservoir (11) and/or the collecting vessel (20) together with the relevant bath (19, 29) are positioned in an enclosed chamber, which can be subjected to a variable pressure, and preferably an underpressure.

15. A device for the distilling of a medium, preferably according to one of the preceding claims, with at least one reservoir (11, 31) for accommodating the medium (15) to be distilled and a heating element (12) for the vaporising of the medium (15), with at least one collecting vessel (20, 40) which is situated downstream, and with a cooling element for the condensing of the produced distillation vapour, as well as with a pipe (18, 28) or the like provided on the top of the reservoir (11, 31) which leads into the collecting vessel (20, 40) and connects the vapour space (14, 24) located inside the reservoir (11, 31) to that which is located inside the collecting vessel (20, 40) whereby an underpressure must be created at least in the vapour space (14, 24) formed by the reservoir (11, 31), characterised in that a number of pairs of simultaneously acting reservoirs (11, 31) and collecting vessels (20, 40) are present, whereby each one of the collecting vessels (20) are connected with a not simultaneously acting reservoir (31) in such a way that the produced distillate (25) that is present in this collecting vessel (20) warms the medium (15) that is contained in the reservoir (31).
